(19) United States
(12) Patent Application Publication
(10) Pub. No.: US 2024/0367120 A1
(43) Pub. Date: Nov. 7, 2024

(54) MANIFOLD ASSEMBLIES FOR GAS PHASE REACTORS AND METHODS FOR OPERATING THE SAME

(71) Applicant: Univation Technologies, LLC, Houston, TX (US)

(72) Inventors: Samuel M. Bernal, Seadrift, TX (US); Simon J. White, Houston, TX (US); Dung P. Le, Houston, TX (US); Michael I. Hurdle, Houston, TX (US); David B. Dentler, Seadrift, TX (US)

(73) Assignee: Univation Technologies, LLC, Houston, TX (US)

(21) Appl. No.: 18/580,866

(22) PCT Filed: Jul. 25, 2022
(86) PCT No.: PCT/US2022/038170

§ 371 Date: Jan. 19, 2024

Related U.S. Application Data
(60) Provisional application No. 63/225,687, filed on Jul. 26, 2021.

(51) Int. Cl. B01F 25/314; B01F 23/232; B01F 35/12; B01F 101/00; B01J 12/00

(52) U.S. Cl. CPC B01F 25/3143; B01F 23/232; B01F 35/12; B01J 12/00; B01F 2101/2204; B01F 2101/2805; B01F 2215/0431; B01F 2215/0486

(57) ABSTRACT

Disclosed herein is a method for polymerizing a compound in a gas phase reactor. The method includes at least passing a liquid catalyst to a catalyst inlet of a manifold assembly, passing a carrier gas to a carrier gas inlet of the manifold assembly, combining the liquid catalyst and the carrier gas in the main channel of the manifold assembly, and passing the combination of the liquid catalyst and the carrier gas to the reaction chamber. The present disclosure is also directed to manifold assemblies for communication with reaction chambers.

### CROSS REFERENCE TO RELATED APPLICATIONS

This PCT application claims priority to U.S. Provisional Patent Application No. 63/225,687, filed on Jul. 26, 2021, the entire disclosure of which is hereby incorporated by reference.

### FIELD

The present disclosure generally relates to gas phase reactors and methods for polymerizing a compound in a gas phase reactor, and more particularly to manifolds used in gas phase reactors.

### BACKGROUND

Polyolefins are included in a wide variety of products such as packaging, molded articles, foams, fibers, etc. Some olefins are polymerized in gas phase by a catalyzed reaction. Some such reactions may utilize catalyst and co-catalysts such as alkylaluminum to form polyolefins. Such olefin polymerization processes may utilize gas phase reactors, such as fluidized beds. This technology has been utilized to successfully produce polyolefins for many years. However, operational drawbacks can reduce profitability and productivity in polyolefin production.

### SUMMARY

In some polymerization techniques, liquid catalyst material may be passed into a reactor unit. The catalyst material may be carried in a gas phase reactant, such as a polymerizable olefin. It has been recognized that the polymerizable olefin may polymerize and foul at the inlet prior to entering the reaction vessel. Such fouling may require shut down of the system for cleaning, which is undesirable. Thus, there is a need for improved inlet assemblies for catalyst materials.

Disclosed herein are embodiments of manifold assemblies which may be utilized to transport catalyst materials into reactor units with reduced fouling. Manifold assemblies according to the present application include minimal discontinuities e.g., minimal or no gaps, thereby reducing the formation of eddy flows and reducing the buildup of catalyst within the manifold assembly. In some embodiments, manifold assemblies according to the present disclosure include cleaning apertures that facilitate simplified cleaning of the manifold assembly.

In one embodiment, a method for polymerizing a compound in a gas phase reactor includes passing a liquid catalyst to a catalyst inlet of a manifold assembly, the manifold assembly including a main body defining a main channel, the catalyst inlet in communication with the main channel, passing a carrier gas to a carrier gas inlet of the manifold assembly, combining the liquid catalyst and the carrier gas in the main channel of the manifold assembly forming a combination of the liquid catalyst and the carrier gas, where the main channel extends in a direction transverse to the catalyst inlet and the carrier gas inlet, and where the main body includes a flange portion defining an outwardly-extending flange and a chamber portion extending at least partially into a reaction chamber, and passing the combination of the liquid catalyst and the carrier gas to the reaction chamber through the chamber portion of the main body.

In another embodiment, a manifold assembly for communication with a reaction chamber includes a catalyst inlet defining a catalyst channel in communication with a main channel, a carrier gas inlet defining a carrier channel in communication with the main channel, a main body including the main channel, a cleaning aperture in communication with the main channel, an outlet positioned opposite the cleaning aperture, the outlet defining an outlet plane and the cleaning aperture defining a cleaning plane, where the cleaning plane and the outlet plane have an unobstructed line of sight between one another, where the main channel extends in a direction transverse to the catalyst inlet and the carrier gas inlet.

In yet another embodiment, a gas phase reactor includes a reaction chamber and a manifold assembly. The manifold assembly may include a catalyst inlet defining a catalyst channel in communication with a main channel, a carrier gas inlet defining a carrier channel in communication with the main channel, a main body including the main channel, a cleaning aperture in communication with the main channel, an outlet positioned opposite the cleaning aperture, the outlet defining an outlet plane and the cleaning aperture defining a cleaning plane, where the cleaning plane and the outlet plane have an unobstructed line of sight between one another, where the main channel extends in a direction transverse to the catalyst inlet and the carrier gas inlet

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a gas phase reactor system, according to one or more embodiments described and depicted herein;

FIG. 2 schematically depicts an enlarged section view of a manifold assembly of the gas phase reactor system of FIG. 1, according to one or more embodiments described and depicted herein;

FIG. 3 schematically depicts a section view of another manifold assembly of the gas phase reactor system of FIG. 1, according to one or more embodiments described and depicted herein; and

FIG. 4 depicts a flowchart of an example method for polymerizing a compound in the gas phase reactor system of FIG. 1, according to one or more embodiments described and depicted herein.

### DETAILED DESCRIPTION

Embodiments described herein are generally directed to manifold assemblies for gas phase reactors including minimal discontinuities, e.g., minimal or no gaps, thereby reducing the formation of eddy flows and reducing the buildup of catalyst within the manifold assembly. In some embodiments, manifold assemblies according to the present disclosure include cleaning apertures that facilitate simplified cleaning of the manifold assembly. These and other embodiments of manifold assemblies for gas phase reactors are disclosed in greater detail herein with reference to the appended figures.

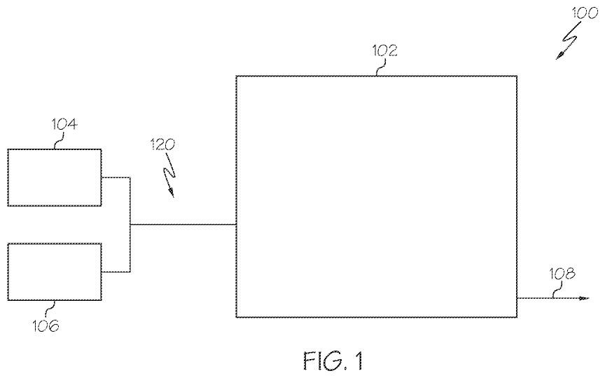

Referring initially to FIG. 1, a gas phase reactor 100 is schematically depicted. In embodiments, the gas phase reactor 100 includes a reaction chamber 102, a catalyst supply 104 in communication with the reaction chamber 102, and a carrier gas supply 106 in communication with the reaction chamber 102.

In the reaction chamber 102, a monomer, and optionally a comonomer, and a catalyst from the catalyst supply 104 are combined under polymerization conditions to produce a polyolefin, for example a homopolymer or a copolymer when comonomer is present. The monomer and comonomer are olefins such as ethylene, propylene, butene-1, hexenes such as 4-methylpentene-1 or hexene-1, octene-1, decene-1 or combinations thereof.

For the purpose of this discussion, the olefin polymerization process will be discussed generally in terms of ethylene polymerization, preferably linear low density polyethylene (LLDPE). However, although the process is generally described as relating to ethylene polymerization, the process is understood as being merely illustrative and is valid for any other polymerization of olefins or combinations of olefins other than or in addition to ethylene. During start-up of a polymerization reactor 102, a bed of polymer particles similar to the polymer to be produced is loaded into the reactor chamber 102. Therefore, a reactor chamber 102 used to make polyethylene may be initially loaded with a LLDPE seedbed during the start-up phase. As the reaction occurs, the initial or starting seedbed will be replaced with an operational polymer bed. For the purpose of this discussion, the initial or starting seedbed and the operational polymer bed will be referred to jointly as a seedbed, e.g. an LLDPE seedbed. Finished polyolefins may pass out of the reactor chamber 102 thorough a reaction outlet 108 of the reaction chamber 102.

In embodiments, the gas phase reactor 100 includes a manifold assembly 120 in communication with the reaction chamber 102. The manifold assembly 120, in embodiments, is in communication with both the catalyst supply 104 and the carrier gas supply 106, such that the catalyst supply 104 and the carrier gas supply 106 are in communication with the reaction chamber 102 through the manifold assembly 120. In embodiments, the catalyst from the catalyst supply 104 and carrier gas from the carrier gas supply 106 may flow through the manifold assembly 120, to the reaction chamber 102.

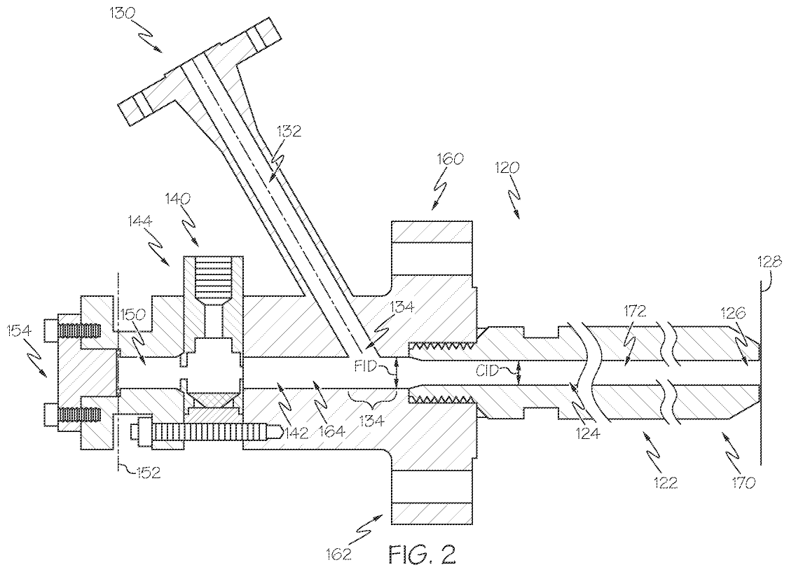

Referring to FIG. 2, a section view of an example manifold assembly 120 is schematically depicted. In embodiments, the manifold assembly 120 includes a catalyst inlet 130, a carrier gas inlet 140, and a main body 122. The catalyst inlet 130 defines a catalyst channel 132 extending through the catalyst inlet 130. The carrier gas inlet 140 defines a carrier channel 142 extending through the carrier gas inlet 140. The main body 122 defines a main channel 124 extending through the main body 122. In embodiments, the carrier channel 142 and the catalyst channel 132 are in communication with the main channel 124. Catalyst from the catalyst supply 104 (FIG. 1), in embodiments, flows through the catalyst channel 132 to the main channel 124, and carrier gas from the carrier gas supply 106 flows through the carrier channel 142 to the main channel 124. In some embodiments, the carrier gas can include any suitable gas, liquid, or liquid/gas mixture to carry the catalyst, for example and without limitation, ethylene, nitrogen gas, and/or an induced condensing agent or agents, or any suitable combination thereof. The catalyst and the carrier gas, in embodiments, combine in the main channel 124, and the combination of catalyst and carrier gas is passed through the main channel 124 to the reaction chamber 102 (FIG. 1). For example, in embodiments, the manifold assembly 120 defines an outlet 126 in communication with the reaction chamber 102 (FIG. 1).

In operation, the mixture of carrier gas from the carrier gas supply 106 (FIG. 1) and catalyst from the catalyst supply 104 (FIG. 1) passes thorough the main channel 124, and through the outlet 126 to the reaction chamber 102 (FIG. 1). In embodiments, the outlet 126 defines an outlet plane 128 that is oriented transverse to the outlet 126. In some embodiments, the main channel 124 extends in a direction transverse to the catalyst inlet 130. In the embodiment depicted in FIG. 2, the carrier gas inlet 140 also extends in a direction transverse to the main channel 124, however, it should be understood that this is merely an example.

In some embodiments, the manifold assembly 120 includes carrier gas valve 144 in communication with the carrier channel 142. The carrier gas valve 144, in embodiments, selectively permits and restricts the flow of carrier gas from the carrier gas supply 106 (FIG. 1) to the carrier channel 142. For example, in some embodiments, the carrier gas valve 144 is positionable at least between a carrier gas open position and a carrier gas closed position. In the carrier gas closed position, the carrier gas valve 144 restricts the flow of carrier gas from the carrier gas supply 106 (FIG. 1) to the carrier channel 142. In the carrier gas open position, the carrier gas valve 144 permits the flow of carrier gas from the carrier gas supply 106 (FIG. 1) to the carrier channel 142.

In some embodiments, the manifold assembly 120 includes a cleaning aperture 150 in communication with the main channel 124. In embodiments, the cleaning aperture 150 defines a cleaning plane 152, where the cleaning plane 152 has an unobstructed line of sight with the outlet plane 128. Because the cleaning plane 152 has an unobstructed line of sight with the outlet plane 128, a cleaning tool, such as a drill, a brush, or the like can be inserted through the cleaning aperture 150 into the main channel 124 through the cleaning plane 152, and can reach the outlet plane 128 unobstructed. Accordingly, because the cleaning plane 152 has an unobstructed line of sight with the outlet plane 128, cleaning of the main channel 124 can be simplified as compared to manifold assemblies that do not include a cleaning plane 152 and outlet plane 128 that enjoy an unobstructed line of sight. In some embodiments, an end cap 154 is selectively coupled to the cleaning aperture 150 of the main body 122. The end cap 154 may be removed from the cleaning aperture 150 of the main body 122 so that the cleaning tool can be inserted into the cleaning aperture 150.

In some embodiments, the manifold assembly 120 defines a flange portion 160 defining an outwardly-extending flange 162, and a chamber portion 170 that extends at least partially into the reaction chamber 102 (FIG. 1). In some embodiments, the main channel 124 defines a flange channel 164 extending at least partially through the flange portion 160 and a chamber channel 172 extending at least partially through the chamber portion 170. In embodiments, the flange channel 164 defines a flange inner diameter FID and the chamber channel 172 defines a chamber inner diameter CID. The flange inner diameter FID and the channel inner diameter CID are different in some embodiments. For example, in the embodiment depicted in FIG. 2, the channel inner diameter CID is less than the flange inner diameter FID. Without being bound by theory, as the inner diameter decreases moving from the flange channel 164 to the chamber channel 172, the velocity of fluid (e.g., a gas and/or fluid mixture of catalyst and carrier gas) passing through the main channel 124 may increase as the fluid moves through the flange channel 164 to the chamber portion 170. In this way, the velocity of the mixture of catalyst from the catalyst supply 104 (FIG. 1) and carrier gas from the carrier gas supply 106 (FIG. 1) may increase as the mixture passes from the flange channel 164 to the chamber channel 172.

In some embodiments, the catalyst inlet 130 defines a catalyst aperture 134 extending through a perimeter of the flange channel 164. For example, in embodiments, the catalyst inlet 130 is in communication with the flange channel 164 through the catalyst aperture 134. As catalyst is passed through the catalyst inlet 130, the catalyst passes through the catalyst aperture 134 to the flange channel 164. In some embodiments, wherein the flange channel inner diameter FID varies by about 1/64 of an inch or less at positions outside of the 134. In some embodiments, the flange channel has an average roughness of about 125 micro-inches or less at positions outside of the catalyst aperture 134.

In some embodiments, the catalyst from the catalyst supply 104 may include metal alkyls, such as triethylaluminum (which is pyrophoric and is also referred to as Teal, TEA, and/or T2) or the like. As the catalyst flows through the catalyst aperture 134 to the flange channel 164, catalyst may deposit along the main channel 124, fouling the main channel 124 and restricting the flow of catalyst and carrier gas through the main channel 124 to the reaction chamber 102. The main channel 124 may need to be periodically cleaned to remove the deposited catalyst along the main channel 124. To clean the main channel 124, a brush or cleaning tool is inserted along the main channel 124. However, many catalysts, such as Teal are reactive with oxygen, and precautions must be taken when cleaning the main channel 124, such that the cleaning process is a complex and time-consuming endeavor, leading to significant process downtime. Accordingly, it is desirable to minimize the buildup of catalyst along the main channel 124.

Without being bound by theory, it is believed that if discontinuities are allowed in the main channel 124, the discontinuities may lead to the buildup of catalyst as the catalyst passes along the main channel 124. For example, such discontinuities along the main channel 124 may cause eddy currents to form, which assists in the buildup or accumulation of catalyst along the main channel 124. Because the catalyst initially flows from the catalyst channel 132 and combines with carrier gas in the flange channel 164, the flange channel 164 may be particularly susceptible to the buildup or accumulation of catalyst. Accordingly, by limiting variation of the flange channel inner diameter FID, discontinuities, for example, gaps, along the flange channel 164 may be minimized, or eliminated which may prevent, delay, or reduce the buildup or accumulation of catalyst along the flange channel 164. Similarly, the flange channel 164 may have a smooth surface finish, for example, an average roughness of about 125 micro-inches or less, which may help minimize buildup or accumulation of the catalyst along the flange channel 164.

In the embodiment depicted in FIG. 2, the flange portion 160 and the chamber portion 170 are coupled to one another. For example, in embodiments, the chamber portion 170 may be threaded into the flange portion 160, such that the chamber portion 170 and the flange portion 160 are coupled via a threaded connection. However, it should be understood that this is merely an example.

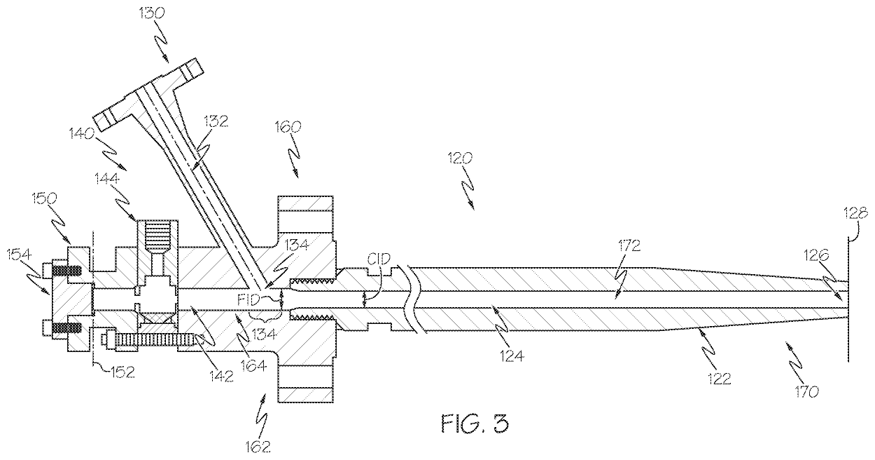

For example and referring to FIG. 3, another embodiment of the manifold assembly 120 is depicted. Like the embodiment described above and depicted in FIG. 2, the manifold assembly 120 includes the catalyst inlet 130, the carrier gas inlet 140, the flange portion 160, and the chamber portion 170. However, in the embodiment depicted in FIG. 3, the flange portion 160 and the chamber portion 170 are monolithic.

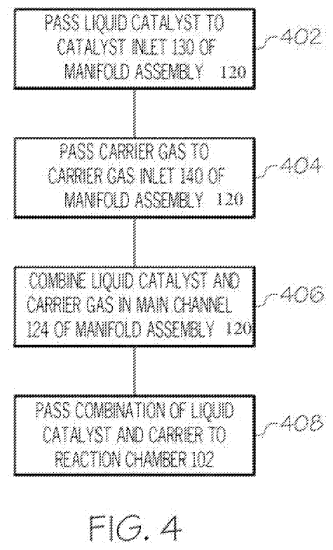

Referring to FIGS. 1-4, a flowchart of one method for polymerizing a compound in a gas phase reactor 100 is depicted. At block 402, a liquid catalyst is passed to the catalyst inlet 130 of the manifold assembly 120, the manifold assembly 120 comprising the main body 122 defining the main channel 124 in communication with the catalyst inlet 130. As noted above, the liquid catalyst can be supplied to the catalyst inlet 130 from the catalyst supply 104. At block 404, a carrier gas is passed to the carrier gas inlet 140 of the manifold assembly 120. At block 406, the liquid catalyst and the carrier gas are combined in the main channel 124 of the manifold assembly 120, forming a combination of liquid catalyst and carrier gas. At block 408, the combination of liquid catalyst and carrier gas are passed to the reaction chamber 102 through the chamber portion 170 of the main body 122.

It should now be understood that embodiments described herein are generally directed to manifold assemblies for gas phase reactors including minimal discontinuities, e.g., minimal or no gaps, thereby reducing the formation of eddy flows and reducing the buildup of catalyst within the manifold assembly. In some embodiments, manifold assemblies according to the present disclosure include cleaning apertures that facilitate simplified cleaning of the manifold assembly.

One or more aspects of the present technology are disclosed herein. In a first aspect, a method for polymerizing a compound in a gas phase reactor may comprise: passing a liquid catalyst to a catalyst inlet of a manifold assembly, the manifold assembly comprising a main body defining a main channel, the catalyst inlet in communication with the main channel; passing a carrier gas to a carrier gas inlet of the manifold assembly; combining the liquid catalyst and the carrier gas in the main channel of the manifold assembly forming a combination of the liquid catalyst and the carrier gas, wherein the main channel extends in a direction transverse to the catalyst inlet and the carrier gas inlet, and wherein the main body comprises a flange portion defining an outwardly-extending flange and a chamber portion extending at least partially into a reaction chamber; and passing the combination of the liquid catalyst and the carrier gas to the reaction chamber through the chamber portion of the main body.

Another aspect includes any above aspect, wherein combining the liquid catalyst and the carrier gas comprises combining the liquid catalyst and the carrier gas in a flange channel extending at least partially through the flange portion, and wherein the main body further comprises a chamber channel extending at least partially through the chamber portion, wherein the flange channel defines a flange inner diameter and the chamber channel defines a chamber inner diameter and the flange inner diameter and the channel inner diameter are different.

Another aspect includes any above aspect, comprising passing the liquid catalyst through a catalyst aperture extending through a perimeter of the flange channel.

Another aspect includes any above aspect, wherein the flange channel inner diameter varies by 1/64″ or less at positions outside of the catalyst aperture.

Another aspect includes any above aspect, the flange channel has an average roughness of 125 micro-inches or less at positions outside of the catalyst aperture.

Another aspect includes any above aspect, wherein passing the carrier gas to the carrier gas inlet comprises passing the carrier gas through a carrier gas valve in communication with the carrier gas inlet, wherein the carrier gas valve is positionable between an open position, in which the carrier gas passes through the carrier gas valve through the carrier gas inlet, and a closed position, in which the carrier gas is restricted from flowing through the carrier gas valve to the carrier gas inlet.

Another aspect includes any above aspect, further comprising: removing an end cap coupled to a cleaning aperture of the main body; inserting a cleaning tool through the cleaning aperture and the main channel of the main body.

Another aspect includes any above aspect, wherein the main body defines an outlet positioned opposite the cleaning aperture, the outlet defining an outlet plane and the cleaning aperture defining a cleaning plane, wherein the cleaning plane and the outlet plane have an unobstructed line of sight between one another.

Another aspect is a manifold assembly for communication with a reaction chamber, the manifold assembly comprising: a catalyst inlet defining a catalyst channel in communication with a main channel; a carrier gas inlet defining a carrier channel in communication with the main channel; a main body comprising: the main channel; a cleaning aperture in communication with the main channel; an outlet positioned opposite the cleaning aperture, the outlet defining an outlet plane and the cleaning aperture defining a cleaning plane, wherein the cleaning plane and the outlet plane have an unobstructed line of sight between one another; wherein the main channel extends in a direction transverse to the catalyst inlet and the carrier gas inlet.

Another aspect includes any above aspect, further comprising: a flange portion defining an outwardly-extending flange; and a chamber portion extending at least partially into a reaction chamber.

Another aspect includes any above aspect, wherein the main channel defines a flange channel extending at least partially through the flange portion and a chamber channel extending at least partially through the chamber portion, wherein the flange channel defines a flange inner diameter and the chamber channel defines a chamber inner diameter and the flange inner diameter and the channel inner diameter are different.

Another aspect includes any above aspect, wherein the catalyst inlet defines a catalyst aperture extending through a perimeter of the flange channel.

Another aspect includes any above aspect, wherein the flange channel inner diameter varies by 1/64″ or less at positions outside of the catalyst aperture.

Another aspect includes any above aspect, wherein the flange channel has an average roughness of 125 micro-inches or less at positions outside of the catalyst aperture.

Another aspect includes any above aspect, wherein the flange portion and the chamber portion are monolithic.

Another aspect includes a gas phase reactor comprising a reaction chamber and the manifold assembly of any above aspect.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It is noted that terms like “preferably.” “commonly.” and “typically.” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A method for polymerizing a compound in a gas phase reactor, the method comprising:
passing a liquid catalyst to a catalyst inlet of a manifold assembly, the manifold assembly comprising a main body defining a main channel, the catalyst inlet in communication with the main channel;
passing a carrier gas to a carrier gas inlet of the manifold assembly;
combining the liquid catalyst and the carrier gas in the main channel of the manifold assembly forming a combination of the liquid catalyst and the carrier gas, wherein the main channel extends in a direction transverse to the catalyst inlet and the carrier gas inlet, and wherein the main body comprises a flange portion defining an outwardly-extending flange and a chamber portion extending at least partially into a reaction chamber; and
passing the combination of the liquid catalyst and the carrier gas to the reaction chamber through the chamber portion of the main body.

2. The method of claim 1, wherein combining the liquid catalyst and the carrier gas comprises combining the liquid catalyst and the carrier gas in a flange channel extending at least partially through the flange portion, and wherein the main body further comprises a chamber channel extending at least partially through the chamber portion, wherein the flange channel defines a flange inner diameter and the chamber channel defines a chamber inner diameter and the flange inner diameter and the channel inner diameter are different.

3. The method of claim 2, further comprising passing the liquid catalyst through a catalyst aperture extending through a perimeter of the flange channel.

4. The method of claim 3, wherein the flange channel inner diameter varies by 1/64″ or less at positions outside of the catalyst aperture.

5. The method of claim 3, the flange channel has an average roughness of 125 micro-inches or less at positions outside of the catalyst aperture.

6. The method of claim 1, wherein passing the carrier gas to the carrier gas inlet comprises passing the carrier gas through a carrier gas valve in communication with the carrier gas inlet, wherein the carrier gas valve is positionable between an open position, in which the carrier gas passes through the carrier gas valve through the carrier gas inlet, and a closed position, in which the carrier gas is restricted from flowing through the carrier gas valve to the carrier gas inlet.

7. The method of claim 1, further comprising:
removing an end cap coupled to a cleaning aperture of the main body;
inserting a cleaning tool through the cleaning aperture and the main channel of the main body.

8. The method of claim 7, wherein the main body defines an outlet positioned opposite the cleaning aperture, the outlet defining an outlet plane and the cleaning aperture defining a cleaning plane, wherein the cleaning plane and the outlet plane have an unobstructed line of sight between one another.

9. A manifold assembly for communication with a reaction chamber, the manifold assembly comprising:
a catalyst inlet defining a catalyst channel in communication with a main channel;
a carrier gas inlet defining a carrier channel in communication with the main channel;
a main body comprising:
the main channel;
a cleaning aperture in communication with the main channel;
an outlet positioned opposite the cleaning aperture, the outlet defining an outlet plane and the cleaning aperture defining a cleaning plane, wherein the cleaning plane and the outlet plane have an unobstructed line of sight between one another;
wherein the main channel extends in a direction transverse to the catalyst inlet and the carrier gas inlet.

10. The manifold assembly of claim 9, further comprising:
a flange portion defining an outwardly-extending flange; and
a chamber portion for extending at least partially into the reaction chamber.

11. The manifold assembly of claim 10, wherein the main channel defines a flange channel extending at least partially through the flange portion and a chamber channel extending at least partially through the chamber portion, wherein the flange channel defines a flange inner diameter and the chamber channel defines a chamber inner diameter and the flange inner diameter and the channel inner diameter are different.

12. The manifold assembly of claim 11, wherein the catalyst inlet defines a catalyst aperture extending through a perimeter of the flange channel.

13. The manifold assembly of claim 12, wherein (i) the flange channel inner diameter varies by 1/64″ or less at positions outside of the catalyst aperture; or (ii) the flange channel has an average roughness of 125 micro-inches or less at positions outside of the catalyst aperture; or (iii) both features (i) and (ii).

14. The manifold assembly of claim 10, wherein the flange portion and the chamber portion are monolithic.

15. A gas phase reactor comprising a reaction chamber and the manifold assembly of claim 9.
